(19) United States
(12) Patent Application Publication
(10) Pub. No.: US 2010/0306256 A1
(43) Pub. Date: Dec. 2, 2010

(54) Distributed Database Write Caching With Limited Durability

(75) Inventor: Timothy J. Blackman, Arlington, MA (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/476,816

(22) Filed: Jun. 2, 2009

(51) Int. Cl. G06F 17/30; G06F 12/00; G06F 12/08

(52) U.S. Cl. 707/770; 711/118; 711/E12.001; 711/E12.026; 707/704

(57) ABSTRACT

A distributed database system includes a central data server, and a plurality of application nodes for receiving connections from clients. Each application node is in communication with the central data server, and has a data cache which maintains local copies of recently used data items. The central data server keeps track of which data items are stored in each data cache and makes callback requests to the data caches to request the return of data items that are needed elsewhere. Data items, including modified data items, are cached locally at a local application node so long as the locally cached data items are only being accessed by the local application node. The local application node handles transactions and stores changes to the data items. The local application node forwards changes, in order by transaction, to the central data server to insure consistency, thereby providing limited durability write caching.

### BACKGROUND OF THE INVENTION

1. Field of the Invention

The invention relates to distributed databases, and to write caching.

2. Background Art

Like many other online applications, online games and virtual worlds produce high volume access to large quantities of persistent data. Although techniques for implementing highly scalable databases for typical online applications are well known, some of the special characteristics of these virtual environments make the standard approaches to database scaling ineffective. To support fast response times for users, the latency of data access is more important than throughput. Unlike most data-intensive applications, where data reads predominate, a higher proportion of data accesses in virtual environments involve data modification, perhaps as high as 50%. Unlike applications involving real world goods and payments, users are more willing to tolerate the loss of data or history due to a failure in the server, so long as these failures are infrequent, the amount of data lost is small, and the recovered state remains consistent. This reduced requirement for data durability provides an opportunity to explore new approaches to scalable persistence that can satisfy the needs of games and virtual worlds for low latency in the presence of frequent writes.

When storing data on a single node, the way to provide low latency is to avoid the cost of flushing modifications to disk. Since these applications can tolerate an occasional lack of durability, a single node system can skip disk flushing so long as it can preserve integrity even if some updates are lost during a node failure. Avoiding disk flushes in this way allows the system to take full advantage of disk throughput. In tests, a database transaction that modifies a single data item takes more than 10 milliseconds if performing a disk flush, but as little as 25 microseconds without flushing.

Network latency poses a similar problem for data storage in multi-node systems. As network speeds have increased, network throughput has increased dramatically, but latency continues to be substantial. In tests using 8 Gigabit Infiniband, only a network round trip latency of at best 40 microseconds was able to be achieved, in this case using standard Java sockets in a prerelease version of Java 7 that uses Sockets Direct Protocol (SDP) to perform TCP/IP operations over Infiniband. Adding an additional 40 microseconds to the current 25 microsecond transaction time threatens to reduce performance significantly.

Web applications use data caching facilities such as Memcached (http://www.danga.com/memcached/) to improve performance when accessing databases. These facilities provide non-transactional access to the data. Fitzpatrick, Brad. 2004. Distributed Caching with Memcached. Linux Journal.

Transactional caches such as JBoss Cache (http://wwwjboss.org/jbosscache/) are also available, but only seem to provide improved performance for reads, not writes. JBoss Cache Users' Guide: A clustered, transactional cache. Release 3.0.0 Naga. October 2008.

Web applications use database partitioning to improve database scaling. Partitioning is most helpful when used for read access in concert with data caching. Once the data is partitioned, transactions that perform data modifications to data stored in multiple databases will incur additional costs for coordination (typically using two phase commit). Ries, Eric. Jan. 4, 2009. Sharding for Startups.

Distributed Shared Memory (Nitzberg, Bill, and Virginia Lo. 1991. Distributed Shared Memory: A Survey of Issues and Algorithms. IEEE Computer: 24, issue 8: 52-60.) is an approach to providing access to shared data for networked computers. The implementation strategies for DSM work best for read access, though, and do not address problems with latency for writes.

The ObjectStore object-oriented database (Lamb, Charles, Gordon Landis, Jack Orenstein, and Dan Weinreb. 1991. The ObjectStore Database System. Communications of the ACM: 34, no. 10: 50-63.) also provided similar read caching facilities.

Berkeley DB (Oracle. Oracle Berkeley DB. Oracle Data Sheet. 2006.) provides a multi-reader, single writer replication scheme implemented using the Paxos algorithm. As with other existing approaches, this scheme improves scaling for reads but not writes.

Further background information may be found in: Agrawal, Rakesh, Michael J. Carey, and Lawrence W. McVoy. December 1987. The Performance of Alternative Strategies for Dealing with Deadlocks in Database Management Systems. IEEE Transactions on Software Engineering: 13, no. 12: 1348-1363. The paper compares different ways of handling deadlock in transaction systems.

### SUMMARY OF THE INVENTION

In one embodiment of the invention, data is cached locally, including modified data, so long as it is only being used by the local node. If local modifications need to be made visible to another application node, because the node wants to access the modified data, then all local changes need to be flushed back to the central server, to insure consistency.

In accordance with one embodiment of the invention, a distributed database system is provided. The distributed database system comprises a central data server which maintains persistent storage for data items, and a plurality of application nodes for receiving connections from clients. Each application node is in communication with the central data server, and has a data cache which maintains local copies of recently used data items. The central data server keeps track of which data items are stored in each data cache and makes callback requests to the data caches to request the return of data items that are needed elsewhere. Data items, including modified data items, are cached locally at a local application node so long as the locally cached data items are only being accessed by the local application node. The local application node handles transactions and stores changes to the data items. The local application node forwards changes, in order by transaction, to the central data server to insure consistency, thereby providing limited durability write caching.

Put another way, the data server is responsible for storing the changes in a way that insures integrity and consistency given the order of the requests it receives. It also needs to provide durability. Since the system permits reduced durability, it is not required to make all changes durable immediately; in particular, it does not need to flush changes to disk before acknowledging them. But it does need to make the changes durable at some point.

The distributed database system may implement access to locally cached data items in a variety of ways. In one implementation, the data cache of the local application node includes a lock manager. The local application node is configured such that, when the local application node attempts to access a locally cached data item, if the data item is not being used in a conflicting mode, the data cache provides access to the data item. If the data item is being used in a conflicting mode, an access request is queued in the lock manager.

The distributed database system may implement access to data items that are unavailable for an attempted access at the local cache in a variety of ways. In one implementation, the local application node is configured such that, when the local application node attempts to access a data item that is unavailable for the attempted access, the data cache contacts the central data server to request the desired access. When the local application node attempts to access a data item that is unavailable for the attempted access and for which the data cache previously contacted the central server to request the desired access, the data cache waits for the results of the previous request for the desired access. The data cache may wait for up to a predetermined timeout for the results of the previous request for the desired access.

Embodiments of the invention comprehend a number of more detailed features that may be implemented in a variety of ways. In one implementation, the local application node is configured such that, when a transaction commits, changes to the data items are stored to update the data cache atomically, and the changes to the data items are stored in a change queue. The local application node forwards the updates from the change queue, in order by transaction, to the central data server to insure consistency. In a further feature, the local application node is configured to remove a data item from the data cache only after any changes made by transactions that accessed that data item have been forwarded to the central data server. Changes to data items may be forwarded to the central data server as the changes become available.

The distributed database system may implement a callback server at an application node in a variety of ways. In one implementation, each application node has a callback server configured to receive callback requests made by the central data server to the data cache to request the return of data items that are needed elsewhere. The callback server is configured such that when a callback request for a particular data item is received, if the particular data item is not being used by any current transactions, and was not used by any transactions whose changes have not been forwarded to the central data server, the application node removes the particular data item from the data cache immediately.

It is appreciated that the central data server may be configured to make downgrade requests to the data caches to request the downgrading of data items that are needed elsewhere from write to read access. In one approach to implementing this feature, the callback server is configured such that when a downgrade request for a particular data item is received, if the particular data item is not being used for write access by any current transactions, and was not used for write access by any transactions whose changes have not been forwarded to the central data server, the application node downgrades the particular data item from write to read access.

Further, the data cache of the application node may include a lock manager, with the callback server being configured such that when a callback request for a particular data item is received, if the particular data item is being used by any current transactions, an access request is queued in the lock manager.

There are many advantages associated with embodiments of the invention. For example, the write caching mechanism in embodiments of the invention may achieve scaling for database access for online game and virtual world applications where database latency must be minimized and writes are frequent. The advantage provided over existing approaches is to avoid network latencies for database modifications so long as data accesses display locality of reference. Previous approaches have not provided significant speed ups for data modifications, only for data reads.

### BRIEF DESCRIPTION OF THE DRAWINGS

FIG. 1 illustrates the architecture for an embodiment of the invention;

FIG. 2 is a flowchart illustrating the local application node attempting to access a data item;

FIG. 3 is a block diagram illustrating general operation of an embodiment of the invention; and

FIG. 4 is a flowchart illustrating the central data server receiving and handling a request for access to a data item.

### DETAILED DESCRIPTION OF THE PREFERRED EMBODIMENT

The following description is for an example embodiment of the invention. Other embodiments are possible. Accordingly, all of the following description is exemplary, and not limiting.

In this embodiment, the idea is to cache data locally, including modified data, so long as it is only being used by the local node. If local modifications need to be made visible to another application node, because the node wants to access the modified data, then all local changes need to be flushed back to the central server, to insure consistency.

This scheme avoids network latency so long as the system can arrange for transactions that modify a particular piece of data to be performed on the same node. It avoids the need for explicit object migration: objects will be cached on demand by the local node. It also permits adding and removing application nodes, and avoids the need for redundancy and backup, since the only unique data stored on application nodes are pending updates that the system is willing to lose in case of a node failure.

### Architecture

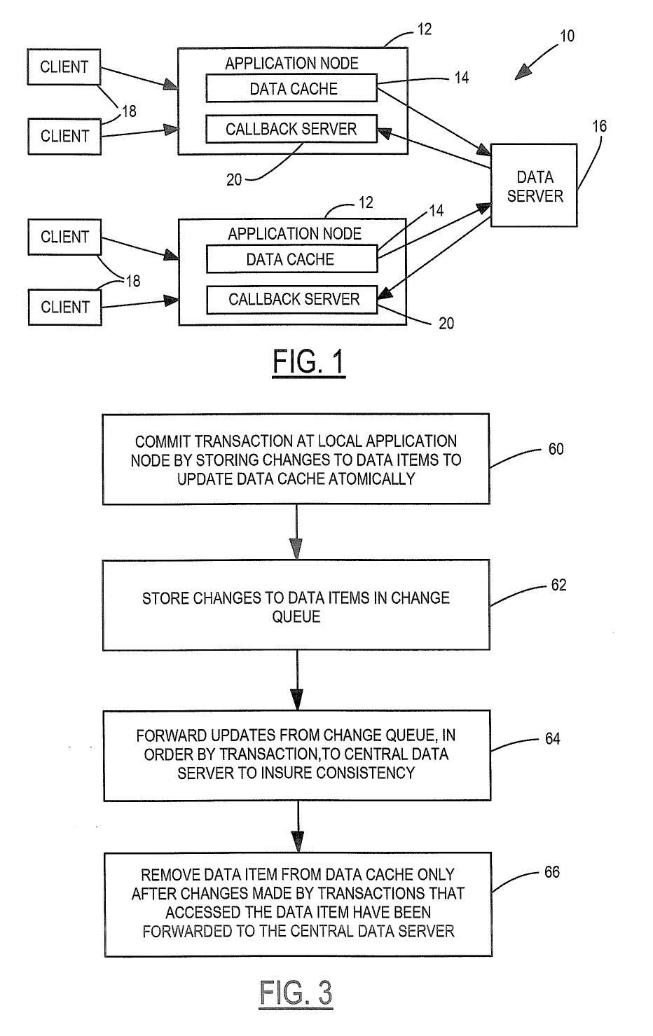

As best shown in FIG. 1, the architecture for an embodiment of the invention is generally indicated at 10. Each application node 12 has its own data cache 14, which maintains local copies of recently used items. Data caches 14 communicate with the central data server 16, which maintains persistent storage for items. The data server 16 also keeps track of which items are stored in which data caches 14, and makes callback requests to those caches 14 to request the return of items that are needed elsewhere.

### Data Cache

When an application node 12 asks the data cache 14 for access to an item, the cache 14 first checks to see if the item is present. If the item is present and is not being used in a conflicting mode (write access by one transaction blocks all other access), then the cache 14 provides the item to the application immediately. If a conflicting access is being made by another transaction, the access request is queued in the data cache's lock manager and blocked until all current transactions with conflicting access, as well as any other conflicting accesses that appear earlier in the queue, have completed.

If the item is not present in the cache 14, or if write access is needed but the item is only cached for read, then the data cache 14 contacts the data server 16 to request the desired access. The request either returns the requested access, or else throws an exception if a timeout or deadlock occurred. If additional transactions request an item for reading from the cache 14 while an earlier read request to the server 16 is pending, the additional access waits for the results of the original request, issuing an additional request as needed if the first one fails.

Because data stored in the data cache 14 can be used by multiple transactions on the application node 12, requests to the data server 16 are not made on behalf of a particular transaction. The lack of a direct connection between transactions and requests means there is a need to decide how to specify the timeout for a request. One possibility would be to provide a specific timeout for each request, based on the time remaining in the transaction that initiated the request. Another approach would be to use a fixed timeout, similar to a standard transaction timeout, and to better model the fact that a request may be shared by multiple transactions. The second approach would increase the chance that a request would succeed so that its results could be used by other transactions on the application node 12, even if the transaction initiating the request had timed out.

When a transaction modifies an item, the modifications are stored during the course of the transaction in the data cache. Caching of modifications can also include caching the fact that particular data items have been removed from the persistence mechanism. In this way, requests for those items can take advantage of the cache to obtain information about the fact that the items are no longer present without needing to consult the central server.

When a transaction commits, the commit will update the data cache 14 with the new values, insuring that the cache updates appear atomically. The changes will then be stored in the change queue, which will forward the updates, in order, to the data server 16. Ordering the updates by transaction insures that the persistent state of the data managed by the data server 16 represents a view of the data as seen by the application node 12 at some point in time. The system does not guarantee that all modifications will be made durable, but it does guarantee that any durable state will be consistent with the state of the system as seen at some, slightly earlier, point in time. Since transactions will commit locally before any associated modifications are made persistent on the server 16, users of the system need to be aware of the fact that a failure of an application node 12 may result in committed modifications made by that node 12 being rolled back.

If an item needs to be evicted from the data cache 14, either to make space for new items or in response to a callback request from the data server 16, the data cache 14 will wait to remove the item until any modifications made by transactions that accessed that item have been sent to the data server 16. This requirement insures the integrity of transactions by making sure that the node 12 does not release locks on any transactional data until all transactions it depends on have completed storing their modifications.

Note that, just for maintaining integrity, the change queue does not need to send changes to the data server 16 immediately, so long as changes are sent before an item is evicted from the cache 14. There is no obvious way to predict when an eviction will be requested, though, and the speed of eviction will affect the time needed to migrate data among application nodes 12. To reduce the time needed for eviction, the best strategy is probably to send changes to the data server 16 as the changes become available. The node 12 need not wait for the server 16 to acknowledge the updates, but it should make sure that the backlog of changes waiting to be sent does not get too large. This strategy takes advantage of the large network throughput typically available without placing requirements on latency. There are various possibilities for optimizations, including reordering unrelated updates, coalescing small updates, and eliminating redundant updates.

The data cache 14 provides a callback server 20 to handle callback requests from the data server 16 for items in the cache 14. If an item is not in use by any current transactions, and was not used by any transactions whose changes have not been flushed to the server 16, then the cache 14 removes the item, or write access to the item if the request is for a downgrade from write to read access, and responds affirmatively. Otherwise, the callback server 20 responds negatively. If the item is in use, the callback server 20 queues a request to the lock manager to access the cached item. When access is granted, or if the item was not in use, the callback server 20 queues the callback acknowledgment to the change queue. Once the acknowledgment has been successfully sent to the data server 16, then the change queue arranges to remove the access from the cache 14.

The data cache 14 assigns a monotonically increasing number to transactions that contained modifications as the changes are added to the change queue at commit time. Items that were used during a transaction are marked with the number of the highest transaction in which they were used. This number is used to determine when an item can be evicted in response to a callback request, as well as for the algorithm the cache 14 uses to select old items for eviction. An item can be evicted if all transactions with lower transaction numbers than the number recorded for the item have had their modifications acknowledged by the server.

For simplicity, it may be desired to specify a fixed number of entries as a way of limiting the amount of data held in the cache 14. Another approach would be to include the size of the item cached in the estimate of cache size, and specify the cache size as a configuration option. A still more complicated approach would involve making an estimate of the actual number of bytes consumed by a particular cache entry, and computing the amount of memory available as a proportion of the total memory limit for the virtual machine.

Experience with Berkeley DB, reinforced by published research (Agrawal et al. 1987), suggests that the data cache 14 should perform deadlock detection whenever a blocking access occurs, and should choose either the youngest transaction or the one holding the fewest locks when selecting the transaction to abort.

### Data Server

The central data server 16 maintains information about which items are cached in the various data caches 14, and whether they are cached for read or write. Nodes 12 that need access to items that are not available in their cache 14 send requests to the data server 16 to obtain the items or to upgrade access. If a requested item has not been provided to any data caches 14, or if the item is only encached for read and has been requested for read, then the data server 16 obtains the item from the underlying persistence mechanism, makes a note of the new access, and returns it to the caller.

If there are conflicting accesses to the item in other data caches 14, the data server 16 makes requests to each of those caches 14 in turn to call back the conflicting access. If all those requests succeed, then the server 16 returns the result to the requesting node 12 immediately. If any of the requests are denied, then the server 16 arranges to wait for notifications from the various data caches 14 that access has been relinquished, or throws an exception if the request is not satisfied within the required timeout.

When the data server 16 supplies an item to a data cache 14, it might be useful for the server 16 to specify whether conflicting requests for that item by other data caches 14 are already queued. In that case, the data cache 14 receiving the item could queue a request to flush the item from the cache 14 after the requesting transaction was complete. This scheme would probably improve performance for highly contended items.

In another approach, when the data server 16 supplies an item to a data cache 14, it might be useful for the server 16 to return the timestamp of the oldest conflicting request. In this way, the data cache 14 could arrange to return the data item to the server 16 when all of the requests from the application node are later than the conflicting one identified by the return value provided by the data server 16.

### Networking and Locking

The data caches 14 and the data server 16 communicate with each other over the network, with the communication at least initially implemented using remote method invocation (RMI), for simplicity. In the future, it might be possible to improve performance by replacing RMI with a simpler facility based directly on sockets. For the data cache's request queue, it might also be possible to improve performance by pipelining requests and using asynchronous acknowledgments.

Both the data cache 14 and the data server 16 have a common need to implement locking, with support for shared and exclusive locks, upgrading and downgrading locks, and blocking. The implementation of these facilities should be shared as much as possible. Note that, because the server does not have information about transactions, there is no way for it to check for deadlocks.

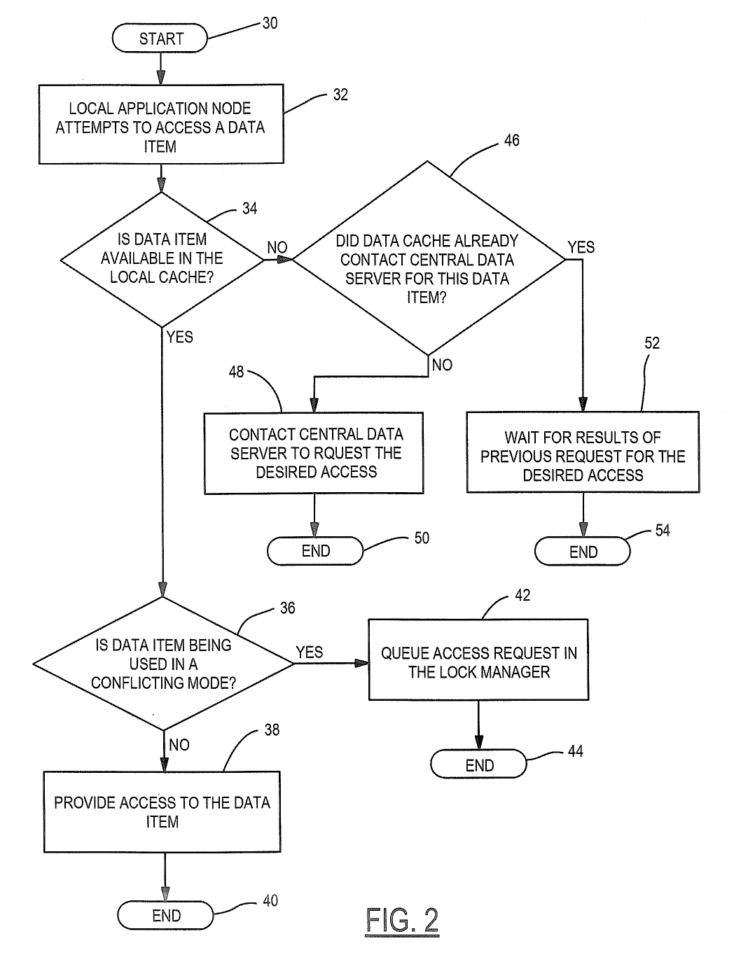

FIG. 2 illustrates the local application node attempting to access a data item. Flow begins at block 30. At block 32, the local application node attempts to access a data item which may or may not be locally cached. At decision block 34, the application node checks to see if the data item is available in the local cache. If the data item is available in the local cache, flow proceeds to decision block 36. At decision block 36, the data cache checks to see if the data item is being used in a conflicting mode. If the data item is not being used in a conflicting mode, flow proceeds to block 38 and the data cache provides access to the data item. Flow ends at block 40.

If the data item is being used in a conflicting mode, flow proceeds to block 42, an access request is queued in the lock manager, and flow ends at block 44.

When, at decision block 34, it is determined that the data item is not available in the local cache, flow proceeds to decision block 46. At decision block 46, it is determined whether the data cache has already contacted the central data server for this data item. If the data cache has not already contacted the central data server, flow proceeds to block 48, the central data server is contacted to request the desired access, and flow ends at block 50. In more detail, it is determined whether the data cache has a request to the data server currently in progress for this data item. If the data cache does not currently have such a request in progress, flow proceeds to block 48.

When, at decision block 46, it is determined that the data cache has already contacted the central data server (that is, that the data cache is in the process of making a request to the central data server), flow proceeds to block 52, the data cache waits for the results of the previous request for the desired access, and flow ends at block 54.

FIG. 3 is a block diagram illustrating general operation of an embodiment of the invention. At block 60, in a method of operating the distributed database system, the method comprises committing a transaction at the local application node by storing changes to the data items to update the data cache atomically. At block 62, the changes to the data items are stored in a change queue. At block 64, the method further includes forwarding, from the local application node, updates from the change queue, in order by transaction, to the central data server to insure consistency. At block 66, a data item may be removed from the data cache only after any changes made by transactions that accessed that data item have been forwarded to the central data server.

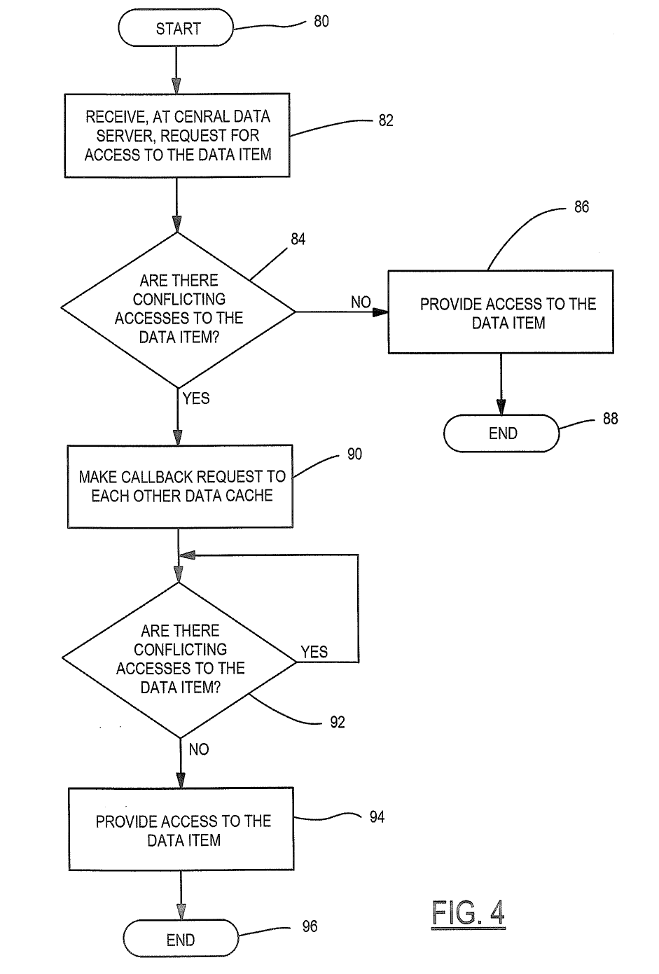

FIG. 4 is a flowchart illustrating the central data server receiving and handling a request for access to a data item. Flow begins at block 80. At block 82, the central data server receives a request for access to a data item. At block 84, a determination is made as to whether there are conflicting access to the data item. If there are no conflicting accesses to the requested data item, access is provided to the data item at block 86 and flow ends at block 88. If there are conflicting accesses to the data item, flow proceeds to block 90 and callback requests are made to each of the other data caches having conflicting access. At decision block 92, when there are no longer any conflicting accesses to the requested data item flow proceeds to block 94 and access to the data item is provided. Flow ends at block 96.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A distributed database system comprising:
a central data server which maintains persistent storage for data items;
a plurality of application nodes for receiving connections from clients, each application node being in communication with the central data server, and having a data cache which maintains local copies of recently used data items;
the central data server keeping track of which data items are stored in each data cache and making callback requests to the data caches to request the return of data items that are needed elsewhere;
wherein data items, including modified data items, are cached locally at a local application node so long as the locally cached data items are only being accessed by the local application node, the local application node handling transactions and storing changes to the data items; and
wherein the local application node forwards changes, in order by transaction, to the central data server to insure consistency, thereby providing limited durability write caching.

2. The distributed database system of claim 1 wherein the data cache of the local application node includes a lock manager, and wherein the local application node is configured such that, when the local application node attempts to access a locally cached data item, if the data item is not being used in a conflicting mode, the data cache provides access to the data item.

3. The distributed database system of claim 2 wherein the local application node is configured such that, when the local application node attempts to access a locally cached data item, if the data item is being used in a conflicting mode, an access request is queued in the lock manager.

4. The distributed database system of claim 1 wherein the local application node is configured such that, when the local application node attempts to access a data item that is unavailable for the attempted access, the data cache contacts the central data server to request the desired access.

5. The distributed database system of claim 4 wherein the local application node is configured such that, when the local application node attempts to access a data item that is unavailable for the attempted access and for which the data cache previously contacted the central server to request the desired access, the data cache waits for the results of the previous request for the desired access.

6. The distributed database system of claim 4 wherein the data cache waits for the results of the previous request for the desired access, the data cache waiting for up to a predetermined timeout.

7. The distributed database system of claim 1 wherein the local application node is configured such that, when a transaction commits, changes to the data items are stored to update the data cache atomically, and the changes to the data items are stored in a change queue, and wherein the local application node forwards the updates from the change queue, in order by transaction, to the central data server to insure consistency.

8. The distributed database system of claim 1 wherein the local application node is configured to remove a data item from the data cache only after any changes made by transactions that accessed that data item have been forwarded to the central data server.

9. The distributed database system of claim 8 wherein changes to data items are forwarded to the central data server as the changes become available.

10. The distributed database system of claim 1 wherein each application node has a callback server configured to receive callback requests made by the central data server to the data cache to request the return of data items that are needed elsewhere; and
wherein the callback server is configured such that when a callback request for a particular data item is received, if the particular data item is not being used by any current transactions, and was not used by any transactions whose changes have not been forwarded to the central data server, the application node removes the particular data item from the data cache.

11. The distributed database system of claim 10 wherein the central data server is configured to make downgrade requests to the data caches to request the downgrading of data items that are needed elsewhere from write to read access; and
wherein the callback server is configured such that when a downgrade request for a particular data item is received, if the particular data item is not being used for write access by any current transactions, and was not used for write access by any transactions whose changes have not been forwarded to the central data server, the application node downgrades the particular data item from write to read access.

12. The distributed database system of claim 10 wherein the data cache of the application node includes a lock manager; and
wherein the callback server is configured such that when a callback request for a particular data item is received, if the particular data item is being used by any current transactions, an access request is queued in the lock manager.

13. A distributed database system comprising:
a central data server which maintains persistent storage for data items;
a plurality of application nodes for receiving connections from clients, each application node being in communication with the central data server, having a data cache which maintains local copies of recently used data items, and having a callback server configured to receive callback requests made by the central data server to the data cache;
the central data server keeping track of which data items are stored in each data cache and making callback requests to the data caches to request the return of data items that are needed elsewhere;
wherein data items, including modified data items, are cached locally at a local application node so long as the locally cached data items are only being accessed by the local application node, the local application node handling transactions and storing changes to the data items;
wherein the local application node forwards changes, in order by transaction, to the central data server to insure consistency, thereby providing limited durability write caching;
wherein the data cache of the local application node includes a lock manager, and wherein the local application node is configured such that, when the local application node attempts to access a data item that is unavailable for the attempted access, the data cache contacts the central data server to request the desired access; and
wherein the callback server at each application node is configured such that when a callback request for a particular data item is received, if the particular data item is not being used by any current transactions, and was not used by any transactions whose changes have not been forwarded to the central data server, the application node removes the particular data item from the data cache.

14. A method of operating the distributed database system of claim 13, the method comprising:
committing a transaction at the local application node, including storing changes to the data items to update the data cache atomically;
storing the changes to the data items in a change queue; and
forwarding from the local application node updates from the change queue, in order by transaction, to the central data server to insure consistency.

15. A method of operating the distributed database system of claim 13, the method comprising:
removing, at the local application node, a data item from the data cache only after any changes made by transactions that accessed that data item have been forwarded to the central data server.

16. The method of claim 15 further comprising:
forwarding changes to data items to the central data server as the changes become available.

17. A method of operating the distributed database system of claim 13, the method comprising:
when the local application node attempts to access a data item that is unavailable for the attempted access, contacting the central data server to request the desired access.

18. The method of claim 17 further comprising:
receiving, at the central data server, a request for access to the data item; and
if there are no conflicting accesses to the requested data item, providing the desired access.

19. The method of claim 18 further comprising:
if there are conflicting accesses to the requested data item in other data caches, making a callback request to each of those other data caches.

20. The method of claim 19 further comprising:
when there are no longer conflicting accesses to the requested data item, providing the desired access.
